(19) United States
(12) Patent Application Publication
(10) Pub. No.: US 2008/0296290 A1
(43) Pub. Date: Dec. 4, 2008

(54) TRANSVERSE FLUX INDUCTION HEATING APPARATUS AND COMPENSATORS

(76) Inventors: Mike Maochang Cao, Westampton, NJ (US); Vitaly A. Peysakhovich, Moorestown, NJ (US)

Correspondence Address: PHILIP O. POST;INDEL, INC., PO BOX 157, RANCOCAS, NJ, 08073, US

(21) Appl. No.: 12/189,644

(22) Filed: Aug. 11, 2008

Related U.S. Application Data
(62) Division of application No. 11/693,310, filed on Mar. 29, 2007.
(60) Provisional application No. 60/787,020, filed on Mar. 29, 2006.

(51) Int. Cl. H05B 6/10

(52) U.S. Cl. 219/635

(57) ABSTRACT

An apparatus and process are provided for inductively heating a workpiece by transverse flux induction. The apparatus comprises a pair of identical coils, each of which includes a reversed head section bent to the opposite side of the workpiece. The assembled pair of coils is configured to effectively form a generally O-shaped coil arrangement on opposing sides of the workpiece. Combination electrically conductive and magnetic compensators, passive or active/passive, are also provided for use with transverse flux inductors.

### CROSS REFERENCE TO RELATED APPLICATIONS

This is a divisional application of application Ser. No. 11/693,310, filed Mar. 29, 2007, which application claims the benefit of U.S. Provisional Application No. 60/787,020, filed Mar. 29, 2006, both of which applications are hereby incorporated herein by reference in their entireties.

### FIELD OF THE INVENTION

The present invention relates to transverse flux induction heating coils and compensators, and in particular, to such apparatus when used to uniformly heat the cross section of a sheet or strip of electrically conductive material.

### BACKGROUND OF THE INVENTION

A typical conventional transverse flux inductor comprises a pair of induction coils. A material to be inductively heated is placed between the pair of coils. For example, in FIG. 1, the coil pair comprises coil 101 and coil 103, respectively located above and below the material, which may be, for example, metal strip 90, which moves continuously through the pair of coils in the direction illustrated by the arrow. For orientation, a three dimension orthogonal space is defined by the X, Y and Z axes shown in FIG. 1. Accordingly the strip moves in the Z direction. The gap, g_{c}, or opening, between the coil pair is exaggerated in the figure for clarity, but is fixed in length across the cross section of the strip. Terminals 101a and 101b of coil 101, and terminals 103a and 103b of coil 103, are connected to one or more suitable ac power sources (not shown in the figures) with instantaneous current pluralities as indicated in the figure. Current flow through the coils creates a common magnetic flux, as illustrated by typical flux line 105 (illustrated by dashed line), that passes perpendicularly through the strip to induce eddy currents in the plane of the strip. Magnetic flux concentrators 117 (partially shown around coil 101 in the figure), for example, laminations or other high permeability, low reluctance materials, may be used to direct the magnetic field towards the strip. Selection of the ac current frequency (f, in Hertz) for efficient induced heating is given by the equation:

$$f = 2 \times {10}^{6} \frac{ρ {g}_{c}}{{τ}^{2} {d}_{s}}$$

where ρ is the electrical resistivity measured in Ω•m; g_{c} is the gap (opening) between the coils measured in meters; τ is the pole pitch (step) of the coils measured in meters; and dₛ is the thickness of the strip measured in meters.

The classical problem to be solved when heating strips by electric induction with a transverse flux inductor is to achieve a uniform cross sectional (along the X-axis), induced heating temperature across the strip. FIG. 2 illustrates a typical cross sectional strip heating profile obtained with the arrangement in FIG. 1 when the pole pitch of the coils is relatively small and, from the above equation, the frequency is correspondingly low. The X-axis in FIG. 2 represents the normalized cross sectional coordinate of the strip with the center of the strip being coordinate 0.0, and the opposing edges of the strip being coordinates +1.0 and −1.0. The Y-axis represents the normalized temperature achieved from induction heating of the strip with normalized temperature 1.0 representing the generally uniform heated temperature across middle region 111 of the strip. Nearer to the edges of the strip, in regions 113 (referred to as the shoulder regions), the cross sectional induced temperatures of the strip decrease from the normalized temperature value of 1.0, and then increase in edge regions 115 of the strip to above the normalized temperature value of 1.0.

There is a need for a transverse flux induction heating apparatus, either in the configuration of the induction coils, or compensators used with the induction coils, that will reduce induced edge overheating and increase induced heating in shoulder regions of the workpiece.

### BRIEF DESCRIPTION OF THE INVENTION

In one aspect, the present invention is an apparatus for, and method of, electric induction heating of an electrically conductive workpiece in the form of a sheet or strip. A transverse flux induction heating apparatus comprises a pair of identical coils, each of which includes a reversed head section bent to the opposite side of the workpiece. The assembled coils are configured to effectively form a generally O-shaped coil arrangement on opposing sides of the workpiece that generates a magnetic field to inductively heat the workpiece.

In another aspect, the present invention is an apparatus for, and method of, electric induction heating of an electrically conductive workpiece in the form of a sheet or strip with a transverse flux electric inductor, wherein a combined flux compensator is used to reduce induced edge heating and increase induced shoulder region heating in the workpiece, respectively.

In another aspect, the present invention is an apparatus for, and method of, electric induction heating of an electrically conductive workpiece in the form of a sheet or strip with a transverse flux electric inductor, wherein a combined active and passive compensator is used. The active compensator reduces induced edge heating and the passive compensator reduces induced edge heating and increases induced shoulder region heating in the workpiece.

These and other aspects of the invention are set forth in this specification and the appended claims.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 illustrates a prior art transverse flux inductor arrangement.

FIG. 2 graphically illustrates typical cross sectional induced heating characteristics for the transverse flux inductor arrangement shown in FIG. 1.

FIG. 3(a) illustrates one example of the transverse flux induction heating apparatus of the present invention.

FIG. 3(b) illustrates one of the two coils comprising the transverse flux induction heating apparatus shown in FIG. 3(a).

FIG. 3(c) illustrates the effective, generally O-shaped coil, over one side of a workpiece resulting from the transverse flux induction heating apparatus shown in FIG. 3(a).

FIG. 3(d) and FIG. 3(e) are elevation views of the transverse flux induction heating apparatus of the present invention shown in FIG. 3(a) through line A-A and line B-B respectively.

FIG. 4(a) illustrates one example of a combined flux compensator of the present invention.

FIG. 4(b) illustrates the compensator shown in FIG. 4(a) with a transverse flux inductor.

FIG. 5(a) illustrates in top planar view one example of a combined active and passive compensator of the present invention.

FIG. 5(b) is an elevation view of the combined compensator shown in FIG. 5(a) through line C-C.

### DETAILED DESCRIPTION OF THE INVENTION

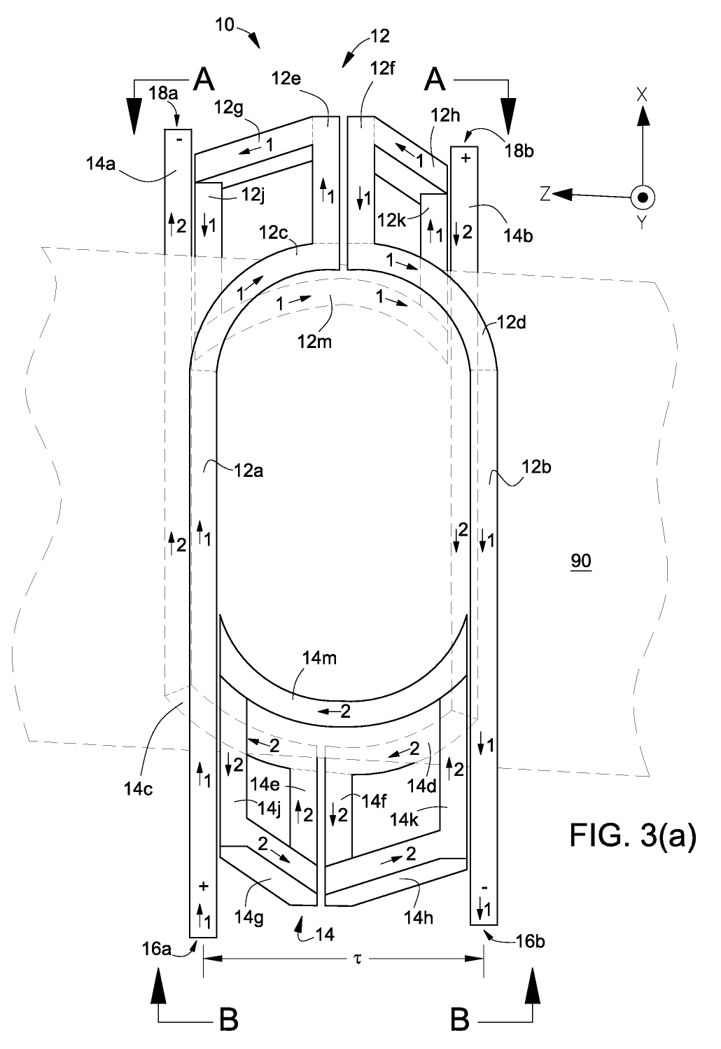

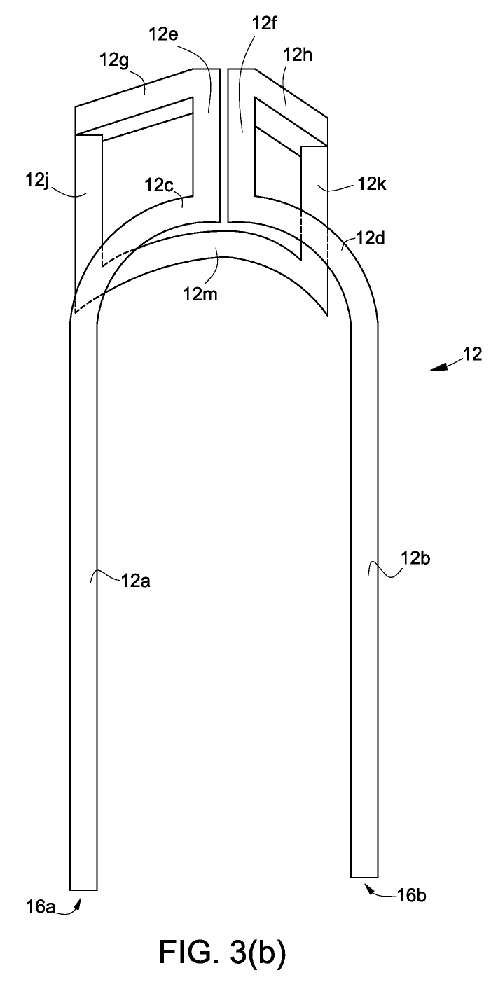

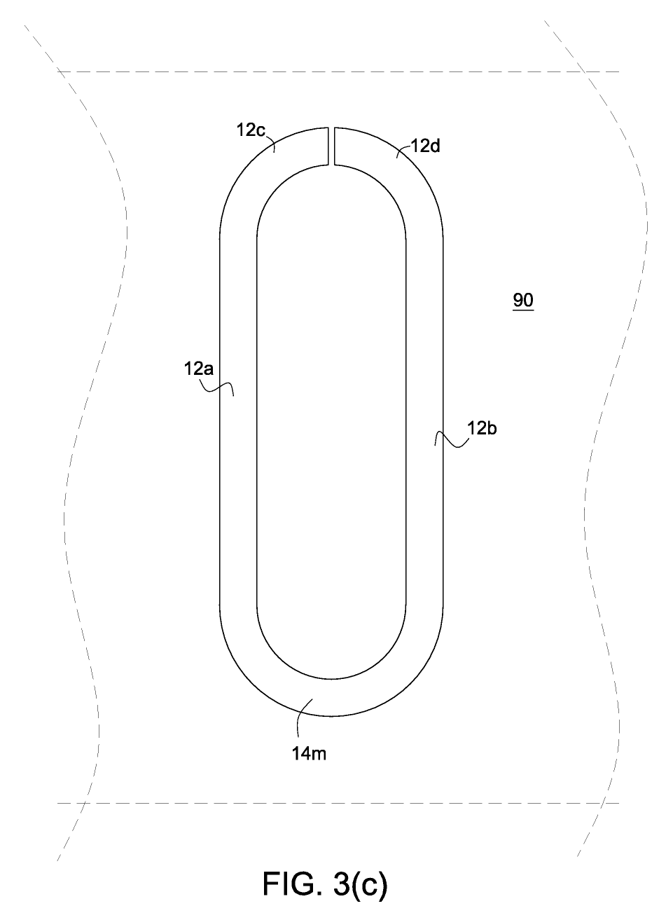

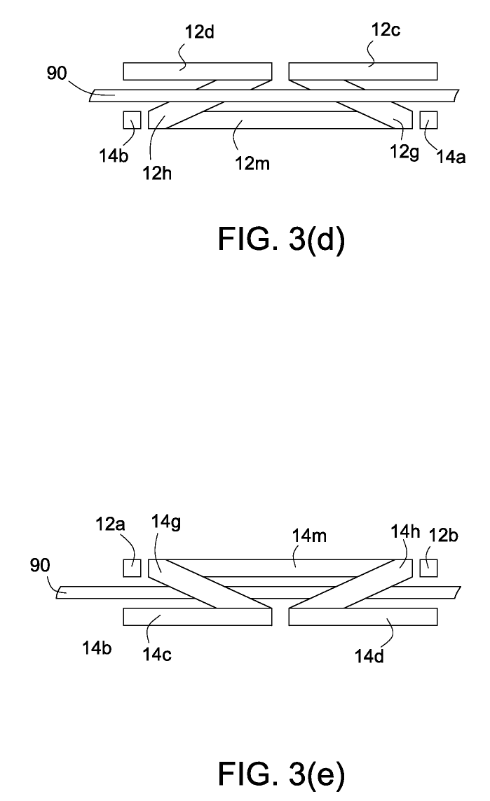

Referring now to the drawings, wherein like numerals indicate like elements, there is shown in FIG. 3(a) through FIG. 3(e) one example of a transverse induction heating apparatus 10, of the present invention. The assembled apparatus, as shown in FIG. 3(a), comprises first and second identical coils 12 and 14 oriented on opposing sides of electrically conductive workpiece 90. The workpiece may be, for example, a metal sheet or strip that passes between the coils. FIG. 3(b) illustrates one of the identical coils, which has a reversed (opposite) head section bent over one edge of the strip. By assembling the two coils on opposing sides of the workpiece as shown in FIG. 3(a), an O-shaped coil effectively results on opposing sides of the workpiece as illustrated in FIG. 3(c) for one side of the workpiece, with each O-shaped coil formed from a pair of transverse coil sections and opposing head coil sections as further described below.

Referring to FIG. 3(a) and FIG. 3(b) coil 12 includes a pair of transverse sections 12a and 12b that extend cross-sectionally over the first side of the strip. Arcuate sections 12c and 12d are connected to the ends of the transverse sections as shown in the figures, and form one of the two head sections for the coil over the first side of the strip. Transverse extension sections 12e and 12f extend beyond the first edge of the strip. Riser sections 12g and 12h are connected at one end to the ends of the transverse extension sections as shown in the figures. The opposing ends of the riser sections are located adjacent to the second side of the strip and are connected to the ends of reverse transverse extension sections 12j and 12k as shown in the figures. The reverse transverse extension sections extend towards the first edge of the strip over the second side of the strip. Arcuate section 12m connects the ends of the reverse transverse extension sections together and forms one of the two head sections for the coil on the second side of the strip.

Coil 14 is similarly constructed of transverse sections 14a and 14b; arcuate sections 14c and 14d; transverse extension sections 14e and 14f, riser sections 14g and 14h; revere transverse extension sections 14j and 14k; and arcuate section 14m. In this non-limiting example the pole pitch, τ, is the same for both coils 12 and 14.

FIG. 3(d) and FIG. 3(e) are side elevations further showing the orientation of coil sections at opposing edges of the strip. In some examples of the invention, the pole pitch of coils 12 and 14 can be varied by changing the angles between the pair of riser sections (12g and 12h, or 14g and 14h, respectively) of coils 12 and 14. In these examples flexible electrical connections may be provided between the pair of riser sections and connected transverse extension and reverse transverse extension sections.

AC power is suitably supplied to coils 12 and 14, for example, by suitable connections to terminals 16a and 16b for coil 12, and terminals 18a and 18b for coil 14, from one or more power supplies (not shown in the figures). Instantaneous orientation of current flows through the coils is indicated by the directional arrows associated with “1” for coil 12 and “2” for coil 14.

In the present invention, adjacent transverse extension sections, adjacent riser sections and adjacent reverse transverse extension sections are configured so that the magnetic fields created by current flows through the adjacent sections of coils 12 and 14 substantially cancel each other as diagrammatically illustrated by the current flow arrows in FIG. 3(a). Current flows in transverse and head coil sections on opposing sides of the strip create a common magnetic flux that passes perpendicularly through the strip and induces eddy currents in the plane of the strip to inductively heat the strip.

Coils 12 and 14 may each be integrally formed from a single piece of suitable electrical conductor such as copper. Alternatively two or more of the sections of either coil may be separately formed and joined together. Magnetic flux concentrators (not shown in the figures), for example, laminations or other high permeability, low reluctance materials, may be located around the coils to direct the magnetic field towards the strip.

In some examples of the invention, either coil 12 or 14, or both coils, may be moved (slid) in the X-direction to accommodate strips of varying widths, or to track sidewise weaving of the strip. One or more suitable mechanical operators (actuators) can be attached to either, or both, coils to accomplish movement of one or both coils.

In other examples of the invention the transverse coils may be skewed relative to the cross section (X-direction) of the workpiece. In the present invention the head sections of coils 12 and 14 are generally arcuate in shape and not further limited in shape; that is, not limited for example, to semicircular shape. While coils 12 and 14 are diagrammatically illustrated here as single turn coils, in practice, the coils may be of alternative arrangements, such as but not limited to, a multi-turn coil or coils, configured either in series, parallel, or combinations thereof.

In summary, in one example of an induction coil of the present invention, a pair of transverse sections of the coil (12a and 12b, or 14a and 14b) are substantially parallel to each other and lie substantially in the same plane. A pair of arcuate sections (12a and 12d, or 14c and 14d) are connected at their first ends to adjacent first ends of the respective pair of transverse sections as shown in FIG. 3(a). The pair of arcuate sections lie substantially in the same plane as the pair of their respective transverse sections. A pair of transverse extension sections (12e and 12f, or 14e and 14f) are connected at their first ends to the second ends of the respective pair of arcuate sections as shown in FIG. 3(a), and extend away from their respective pair of transverse sections. A pair of riser sections (12g and 12h, or 14g and 14h) are connected at their first ends to the second ends of their respective pair of transverse extension sections as shown in FIG. 3(a), and extend away from the plane of their respective pair of transverse sections. As best seen in FIG. 3(d) and FIG. 3(f), the second ends of the respective pair of riser sections are spread further apart than the first ends of the respective riser sections to form an angle between the riser sections. A pair of reverse transverse extension sections (12j and 12k, or 14j and 14k) are connected at their first ends to the second ends of their respective pair of riser sections, and are in a plane substantially parallel to the plane of the respective pair of transverse sections and extend in the direction of their pair of transverse sections. A closing arcuate section (12m or 14m) is connected at its opposing ends to the second ends of the respective reverse transverse extension sections. An induction heating apparatus can be formed from two of the induction coils described above by orienting the second coil (14) below the first coil (12) with the closing arcuate section (14m) of the second coil between the pair of transverse sections (12a and 12b) of the first coil (12) in the vicinity of one edge of strip 90 that is between the first and second coils. At the opposing edge the closing arcuate section (12m) of the first coil is between the pair of transverse sections (14a and 14b) of the second coil as shown in FIG. 3(a).

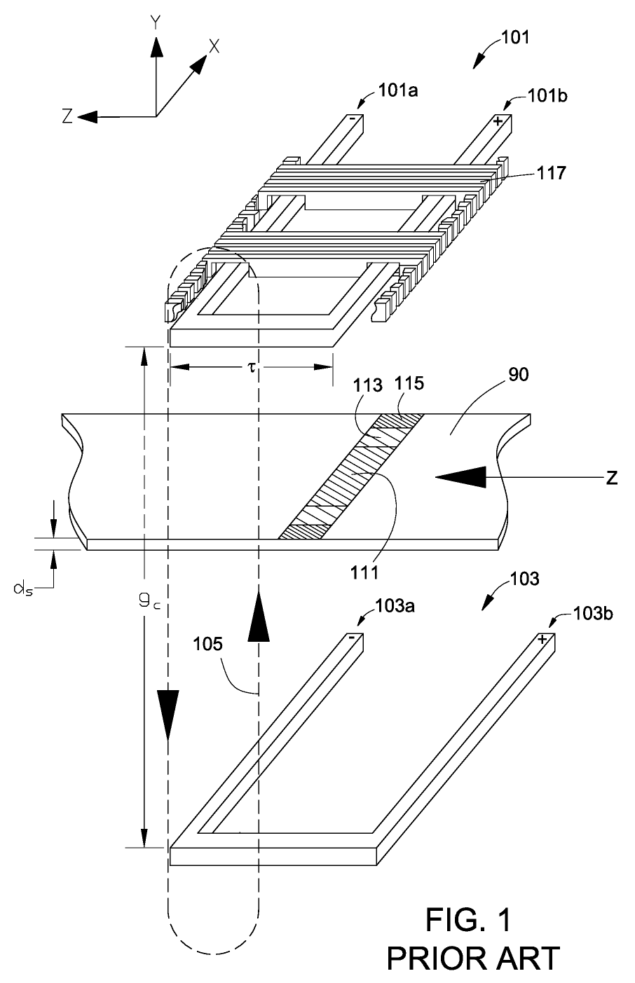

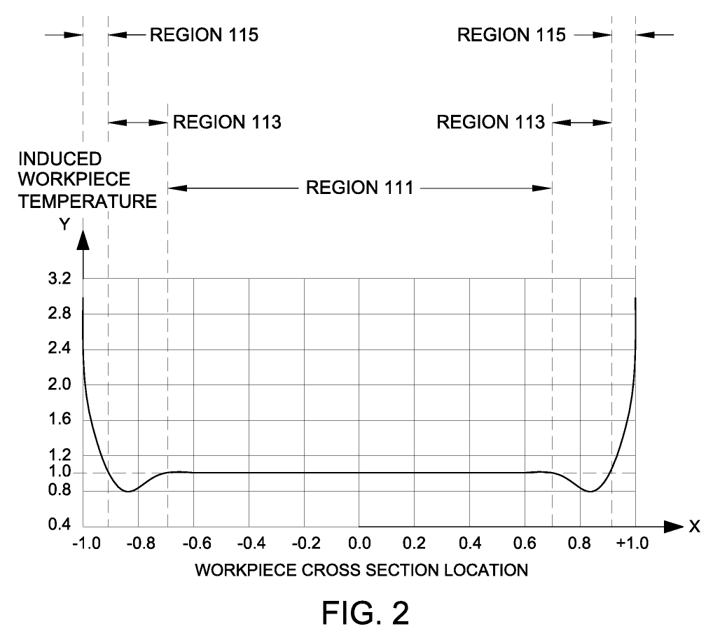

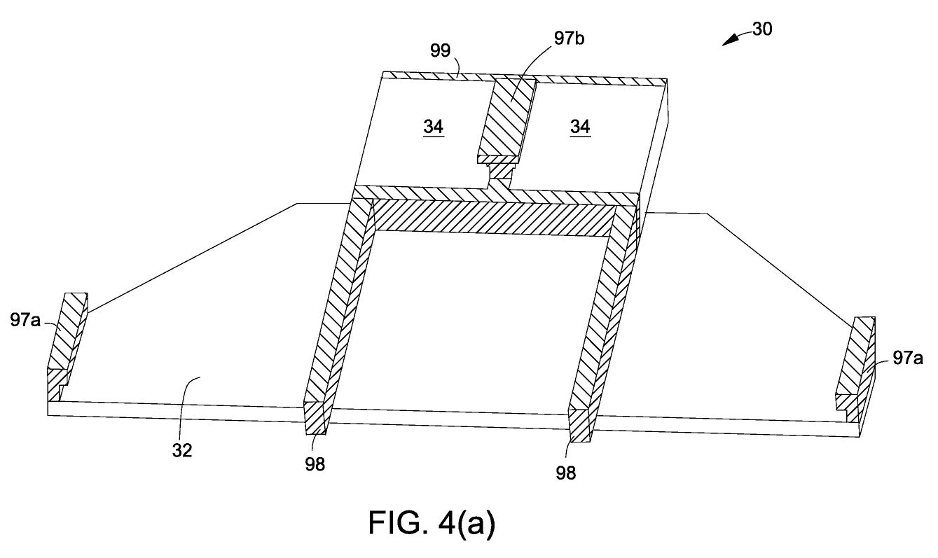

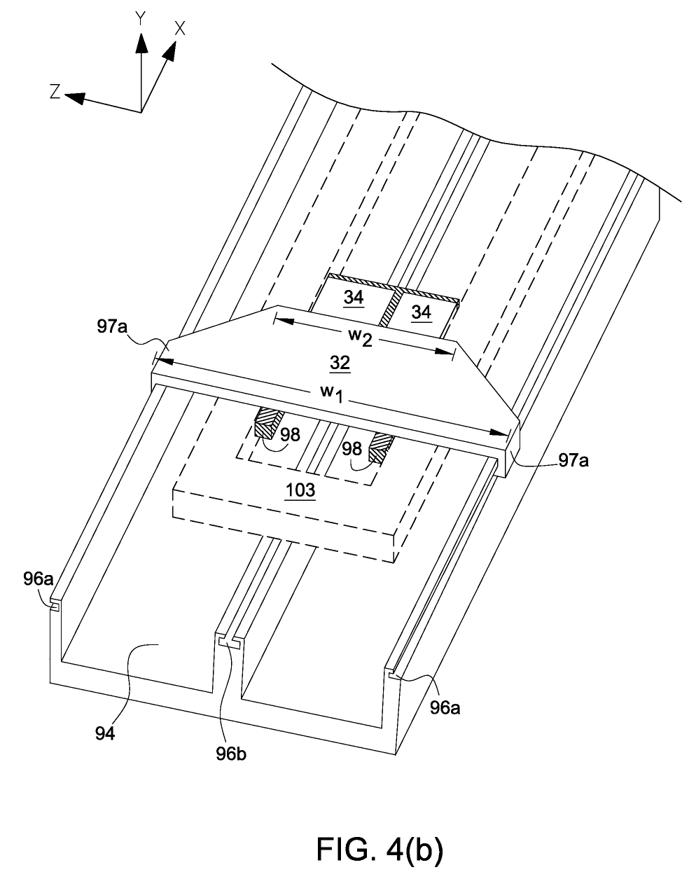

The above transverse flux induction heating apparatus is an improvement over the conventional transverse flux inductor shown in FIG. 1. Alternatively edge and shoulder region induced heating characteristics of the conventional transverse flux inductor shown in FIG. 1 may be improved by using one of the combined compensators of the present invention with a conventional transverse flux inductor. One example of a combined flux compensator of the present invention is the combined electrically conductive and magnetic (passive) compensator 30 shown in FIG. 4(a). Electrically conductive material 32 is used in combination with magnetic material 34 to prevent induced overheating in the edge regions and provide increased induced heating in the shoulder (knee) regions to overcome the prior art conditions illustrated in FIG. 2. Structural element 99, guide blocks 98, side and center inserts 97a and 97b in FIG. 4(a) represent one non-limiting method of containing the electrically conductive and magnetic materials. The electrically conductive material serves as a flux shield and the magnetic material serves as a flux concentrator. The electrically conductive material may be, for example, a planarly oriented copper plate. The magnetic material may be, for example, a planarly oriented block formed from an iron composition. The combined passive flux compensator 30 may be installed between a transverse flux induction coil and strip as shown in FIG. 4(b) with the transverse flux coil identified as element 103 (in dashed lines). The electrically conductive material is generally positioned over the edge region 115 of the strip (not shown in FIG. 4(b) for clarity; refer to FIG. 1 and FIG. 2). Generally the electrically conductive material 32 has one end with a longer width, w₁, closer to the head of the coil (edge region of the strip), and a second opposing end (adjacent to an edge of the magnetic material) with a shorter width, w₂, closer to the shoulder region of the strip, to provide adequate shielding around the head of the coil. The magnetic material is generally positioned over the shoulder region 113 of the strip (not shown in FIG. 4(b) for clarity; refer to FIG. 1 and FIG. 2). Further as shown FIG. 4(b) the combined passive flux compensator may be moveable mounted along the transverse of the coil (X-direction) so that the compensator can be moved to optimize compensation as the width of the strip changes, or a strip sways sidewise as it passes through a pair of coils making up the transverse flux inductor. One method of moving the compensator is shown in FIG. 4(b). In this non-limiting arrangement, coil 103 is situated in enclosure 94, which includes insert side grooves 96a and insert center groove 96b. Side inserts 97a and center insert 97b are attached to the combined concentrator as shown in the figures and are inserted into side grooves and center groove, respectively, to allow the combined concentrator to slide in the transverse direction of the coil. Guide blocks 98 may be provided to assist in keeping the combined flux concentrator in transverse alignment with the coil. Structural element 99 can provide a housing for the magnetic material and method of attaching the magnetic material to the electrically conductive material.

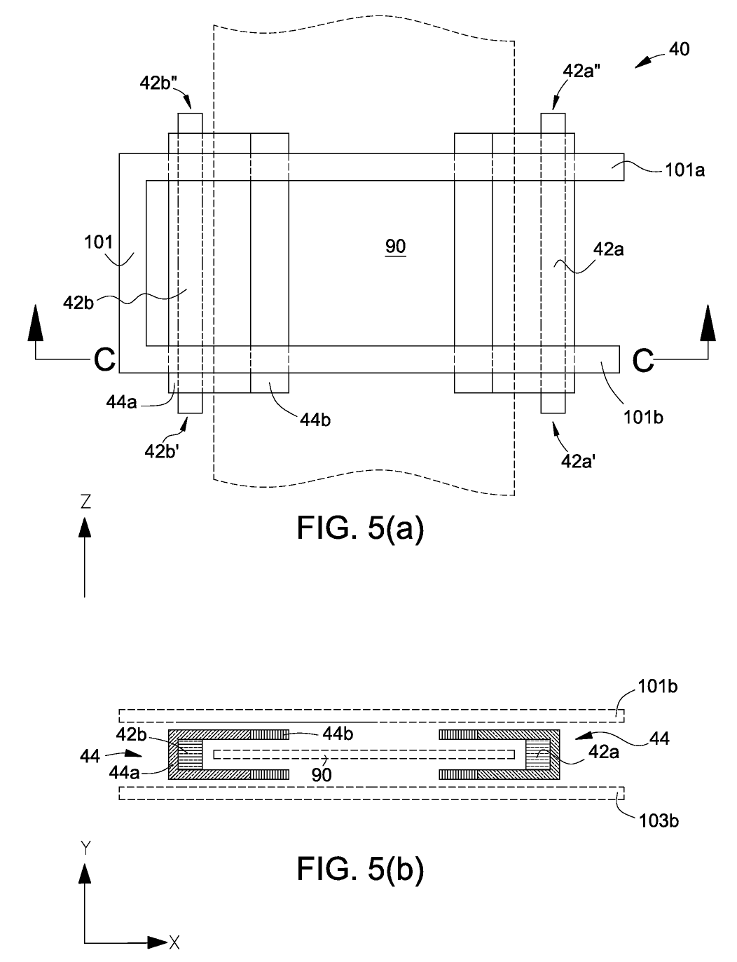

FIG. 5(a) and FIG. 5(b) illustrate one example of a combined active and passive compensator 40 of the present invention, which can be used with the transverse flux induction coils 101 and 103 shown in FIG. 1, with strip 90 located between the coils. The active compensator in this non-limiting example comprises the pair of electrical conductors 42a and 42b, which are located adjacent to the opposing edges of the strip. Each conductor is connected to an ac power source operating at the same frequency as the one or more power supplies providing ac power to coils 101 and 103, or to the same power supplies. Power connections may be made, for example, at terminals 42a′ and 42a″ for coil 42a, and at terminals 42b′ and 42b″ for coil 42b. The magnetic fields created around conductors 42a and 42b push currents induced in the strip (from the magnetic fields created by current flow in coils 101 and 103) away from the edges of the strip to reduce the previously described edge overheating. The passive compensator in this non-limiting example comprises two U-shaped passive compensators 44. A U-shaped passive compensator is located between coils 101 and 103, and around each edge of the strip as shown in FIG. 5(a) and FIG. 5(b). Each U-shaped passive compensator 44 comprises electrically conductive (e.g. copper) element 44a in combination with magnetic element 44b (e.g. iron laminations) connected to the legs of the U-shaped electrically conductive element as shown in the figures. In this non-limiting example of the invention, the base and upper leg segments of the U-shaped passive compensator 44 comprise the electrically conductive element 44a, and the lower legs of the U-shaped passive compensator comprises magnetic element 44b. The electrically conductive element, located around the edge of the strip, decreases induced heating in the edge regions of the strip; and the magnetic element, located approximately above and below the shoulder regions of the strip, increases induced heating in the shoulder regions of the strip. In this non-limiting example, U-shaped passive compensators 44 are fitted around conductors 42a and 42b as shown in the figures. Combined active and passive compensator 40 may be connected to suitable mechanical operators (actuators) that move the compensator towards or away from the edge of the strip (in the X-direction) as the width of a strip changes, or a strip sways sidewise as it passes between the coils.

The above examples of the invention have been provided merely for the purpose of explanation and are in no way to be construed as limiting of the present invention. While the invention has been described with reference to various embodiments, the words used herein are words of description and illustration, rather than words of limitations. Although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto, and changes may be made without departing from the scope of the invention in its aspects.

1. An induction heating coil comprising:
a pair of transverse sections substantially parallel to each other and spaced apart by a pole pitch distance;
a pair of arcuate sections, each one of the pair of arcuate sections exclusively connected at a first end to one of the adjacent first ends of the pair of transverse sections, the pair of arcuate sections disposed substantially in the same plane as the pair of transverse sections, the second ends of the pair of arcuate sections adjacent to each other;
a pair of transverse extension sections, each one of the pair of transverse extension sections exclusively connected at a first end to one of the second ends of the pair of arcuate sections, the pair of transverse extension sections extending away from the pair of transverse sections;
a pair of riser sections, each one of the pair of riser sections exclusively connected at a first end to one of the second ends of the pair of transverse extension sections, the pair of riser sections extending away from the plane of the pair of transverse sections, the second ends of the pair of riser sections spread further apart than the first ends of the pair of riser sections to form an angle between the pair of riser sections;
a pair of reverse transverse extension sections, each one of the pair of reverse transverse extension sections exclusively connected at a first end to one of the second ends of the pair of riser sections, the pair of reverse transverse extension sections disposed in a plane substantially parallel to the plane of the pair of transverse sections and extending in the direction of the pair of transverse sections; and
a closing arcuate section connected at opposing ends to the second ends of the pair of reverse transverse extension sections.

2. The induction heating coil of claim 1 wherein all sections are integrally formed from a suitable electrically conducting material as a single continuous electrical conductor.

3. The induction heating coil of claim 1 further comprising a flexible connection between the pair of riser sections and connecting pair of transverse extension sections or reverse transverse extension sections to vary the pole pitch by changing the angle between the pair of riser sections.

4. An induction heating apparatus comprising:
at least one pair of first and second coils;
the first coil comprising:
a pair of transverse sections substantially parallel to each other and spaced apart by a pole pitch distance;
a pair of arcuate sections, each one of the pair of arcuate sections exclusively connected at a first end to one of the adjacent first ends of the pair of transverse sections, the pair of arcuate sections disposed substantially in the same plane as the pair of transverse sections, the second ends of the pair of arcuate sections adjacent to each other;
a pair of transverse extension sections, each one of the pair of transverse extension sections exclusively connected at a first end to one of the second ends of the pair of arcuate sections, the pair of transverse extension sections extending away from the pair of transverse sections;
a pair of riser sections, each one of the pair of riser sections exclusively connected at a first end to one of the second ends of the pair of transverse extension sections, the pair of riser sections extending away from the plane of the pair of transverse sections, the second ends of the pair of riser sections spread further apart than the first ends of the pair of riser sections to form an angle between the pair of riser sections;
a pair of reverse transverse extension sections, each one of the pair of reverse transverse extension sections exclusively connected at a first end to one of the second ends of the pair of riser sections, the pair of reverse transverse extension sections disposed in a plane substantially parallel to the plane of the pair of transverse sections and extending in the direction of the pair of transverse sections; and
a closing arcuate section connected at opposing ends to the second ends of the pair of reverse transverse extension sections; and
the second coil substantially identical to the first coil, and oriented below the first coil, the second adjacent ends of the pair of transverse sections of the first coil disposed generally adjacent to the pair of reverse transverse extension sections and the closing arcuate section of the second coil.

5. The induction heating apparatus of claim 4 wherein all sections of the first and second sections are integrally formed from a suitable electrically conducting material as a single continuous electrical conductor.

6. The induction heating apparatus of claim 4 further comprising a magnetic flux concentrator at least partially surrounding the first or second coil.

7. The induction heating apparatus of claim 4 further comprising a flexible connection between the pair of riser sections and connecting pair of transverse extension sections or reverse transverse extension sections to vary the pole pitch by changing the angle between the pair of riser sections.

8. The induction heating apparatus of claim 4 further comprising an actuator for moving at least one of the first or second coils in a direction substantially parallel to the lengths of the pair of transverse sections.

9. The induction heating apparatus of claim 4 further comprising at least one ac power supply connected to the second adjacent ends of the pair of transverse sections of the first and second coils so that the magnetic fields created by ac current flow from the at least one power supply substantially cancel around transverse extension sections of each coil, riser sections of each coil, and reverse transverse extension sections of each coil with adjacent sections of the first and second coils.
